(19) United States
(12) Patent Application Publication
(10) Pub. No.: US 2026/0241680 A1
(43) Pub. Date: Aug. 20, 2026

(54) PRINTING DEVICE

(71) Applicant: SEIKO EPSON CORPORATION, TOKYO (JP)

(72) Inventors: Ryo OKUHARA, MATSUMOTO-SHI (JP); Takanori FUKUZAWA, MATSUMOTO-SHI (JP)

(21) Appl. No.: 19/545,100

(22) Filed: Feb. 20, 2026

(30) Foreign Application Priority Data
Feb. 20, 2025 (JP) 2025-025682

(51) Int. Cl. B41J 2/045; B41J 11/00; B41J 25/00

(52) U.S. Cl. CPC B41J 2/04573; B41J 2/0451; B41J 2/04586; B41J 11/007; B41J 11/008; B41J 11/0095; B41J 25/005

(57) ABSTRACT

A printing device includes: a printing unit that prints a job image and an adjustment image, the printing unit including a head and a carriage in which the head is installed and that moves in a scanning direction; a detection unit that is installed in the carriage and that detects the adjustment image; a conveyance unit that relatively conveys a medium with respect to the printing unit in a conveyance direction; and a control unit that adjusts an ejection timing, based on a detection result of the adjustment image by the detection unit, and the control unit causes the printing unit to print the adjustment image such that the adjustment image is arranged side by side with the job image and a distance thereof to an upstream end of the job image is shorter than a distance thereof to a downstream end of the job image.

The present application is based on, and claims priority from JP Application Serial Number 2025-025682, filed February 20, 2025, the disclosure of which is hereby incorporated by reference herein in its entirety.

### BACKGROUND

### 1. Technical Field

The present disclosure relates to a printing device.

### 2. Related Art

JP-A-2012-210773 describes a printing device including a printing unit that ejects a liquid while scanning a medium and thus prints a job image on the medium. The printing device is configured to print an adjustment image including one or more adjustment patterns in order to align the landing position of a liquid ejected from the printing unit at a first ejection timing with the landing position of a liquid ejected from the printing unit at a second ejection timing. The printing device adjusts the first ejection timing and the second ejection timing by detecting the adjustment image.

JP-A-2012-210773 is an example of the related art.

In such a printing device, when the adjustment image is printed so as to be arranged side by side with the job image in the conveyance direction of the medium, the amount of medium consumption is likely to increase. However, when the adjustment image is printed so as to be arranged side by side with the job image in the scanning direction of the printing unit, an

increase in the time required for detecting the adjustment image needs to be suppressed.

### SUMMARY

According to an aspect of the present disclosure, a printing device includes: a printing unit that prints a job image and an adjustment image on a medium, the printing unit including a head that ejects a liquid onto the medium and a carriage in which the head is installed and that moves in a scanning direction with respect to the medium; a detection unit that is installed in the carriage and that detects the adjustment image including one or more adjustment patterns; a conveyance unit that relatively conveys the medium with respect to the printing unit in a conveyance direction different from the scanning direction; and a control unit that adjusts an ejection timing of the liquid, based on a detection result of the adjustment image by the detection unit, and the control unit causes the printing unit to print the adjustment image such that the adjustment image is arranged side by side with the job image in the scanning direction and a distance thereof to an upstream end of the job image is shorter than a distance thereof to a downstream end of the job image in the conveyance direction.

### BRIEF DESCRIPTION OF THE DRAWINGS

FIG. 1 is a schematic view showing an example of a printing device.

FIG. 2 is a bottom view of a head showing a nozzle surface.

FIG. 3 shows a layout of a job image, an adjustment image, and a check image.

FIG. 4 shows an example of an adjustment pattern.

FIG. 5 shows an example of the adjustment image.

FIG. 6 shows a layout of a main adjustment image.

FIG. 7 is a flowchart illustrating an example of printing processing.

### DESCRIPTION OF EMBODIMENTS

Hereinafter, an example of a printing device will be described with reference to the drawings. The printing device is an inkjet printer that ejects an ink, which is an example of a liquid, onto a medium such as a paper, a fabric, or a film, and thus prints an image such as a character or a photograph.

### Printing Device

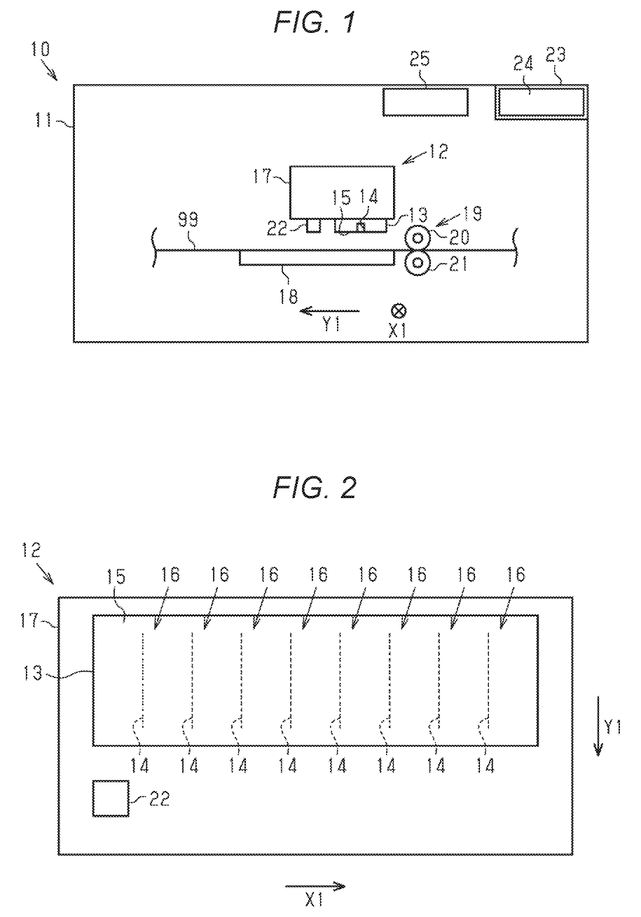

As illustrated in FIG. 1, a printing device 10 includes a housing 11. The housing 11 houses various components provided in the printing device 10.

The printing device 10 includes a printing unit 12. The printing unit 12 is configured to print an image on a medium 99. Specifically, the printing unit 12 ejects a liquid onto the medium 99 and thus prints an image on the medium 99. The printing unit 12 is not limited to ejecting an ink and may eject a liquid material containing particles of a functional material such as an electrode material or a pixel material dispersed, mixed, or dissolved in a liquid.

The printing unit 12 includes a head 13. The head 13 is configured to eject a liquid onto the medium 99. The head 13 has a nozzle surface 15 provided with one or more nozzles 14. In one example, a plurality of nozzles 14 are opened in the nozzle surface 15 of the head 13. The nozzle surface 15 faces the medium 99. The head 13 ejects the liquid from the nozzles 14.

As shown in FIG. 2, the plurality of nozzles 14 form one or more nozzle rows 16 on the nozzle surface 15. The plurality of nozzles 14 form, for example, a plurality of nozzle rows 16 on the nozzle surface 15. In one example, the plurality of nozzles 14 form eight nozzle rows 16 on the nozzle surface 15.

The nozzle row 16 is formed by the plurality of nozzles 14 arranged in one direction. In one example, the nozzle row 16 is formed by the plurality of nozzles 14 arranged in a conveyance direction Y1. Therefore, the nozzle row 16 extends in the conveyance direction Y1. The conveyance direction Y1 is a relative direction in which the medium 99 is conveyed with respect to the printing unit 12. The plurality of nozzle rows 16 are arranged in a direction different from the conveyance direction Y1. The plurality of nozzle rows 16 are arranged in a scanning direction X1. The scanning direction X1 is, for example, a direction serving as an indicator indicating the width of the medium 99.

The printing unit 12 includes a carriage 17. The head 13 is installed in the carriage 17. The carriage 17 is configured to scan the medium 99. The carriage 17 is configured to move in the scanning direction X1 with respect to the medium 99. The carriage 17 is configured to make a reciprocating motion along the scanning direction X1. An individual reciprocating motion of the carriage 17 is referred to as a pass. The carriage 17 moves across the medium 99 over the width of the medium 99. When scanning the medium 99, the carriage 17 moves on an outward path or on a return path. In one example, the carriage 17 moves on the outward path when moving in the scanning direction X1. The carriage 17 moves on the return path when moving in the direction opposite to the scanning direction X1.

As illustrated in FIG. 1, the printing device 10 includes a support unit 18. The support unit 18 is configured to support the medium 99. The support unit 18 is located to face the printing unit 12. The support unit 18 is located to face the nozzle surface 15.

The printing device 10 includes a conveyance unit 19. The conveyance unit 19 is configured to convey the medium 99 relatively to the printing unit 12 in the conveyance direction Y1. In one example, the conveyance unit 19 is configured to convey the medium 99. The conveyance unit 19 conveys the medium 99 in the conveyance direction Y1. The conveyance unit 19 may be configured to move the printing unit 12. For example, the conveyance unit 19 may be configured to move the printing unit 12 in the direction opposite to the conveyance direction Y1 with respect to the medium 99. In this case, the medium 99 is conveyed relatively to the printing unit 12. As described above, the printing device 10 may be a flatbed printer using a gantry or the like.

The conveyance unit 19 is configured to intermittently convey the medium 99 during printing. That is, the conveyance unit 19 is configured to repeat the conveyance and stop of the medium 99 during printing. For example, the conveyance unit 19 is configured to convey the medium 99 by a predetermined amount in the conveyance direction Y1 each time the printing unit 12 makes a reciprocating motion along the scanning direction X1. For example, the conveyance unit 19 stops the medium 99 while the printing unit 12 is making a reciprocating motion along the scanning direction X1. The conveyance unit 19 conveys the medium 99 in the conveyance direction Y1, for example, while the printing unit 12 is stopped. The conveyance of the medium 99 and the movement of the printing unit 12 may be executed so as to partially overlap each other.

The conveyance unit 19 may be configured to convey a long medium 99. The conveyance unit 19 may be configured to convey the medium 99, for example, from a roll body formed of the medium 99 that is wound. The conveyance unit 19 may be configured to convey a single-sheet medium 99. The conveyance unit 19 may be configured to convey the medium 99, for example, from a cassette, a tray or the like on which a plurality of media 99 are loaded.

The conveyance unit 19 may be configured to perform reverse conveyance of the medium 99 relatively to the printing unit 12. That is, the conveyance unit 19 may be configured to convey the medium 99 relatively to the printing unit 12 in the direction opposite to the conveyance direction Y1. That is, the conveyance unit 19 is configured to be able to execute the reverse conveyance of conveying the medium 99 in the direction opposite to the conveyance direction Y1. Here, the conveyance direction Y1 is a direction in which the medium 99 is intermittently conveyed during printing, and is a direction along the medium 99. Hereinafter, a position on the conveyance direction Y1 side with respect to any position is referred to as downstream. Similarly, a position opposite to the conveyance direction Y1 with respect to any position is referred to as upstream.

The conveyance unit 19 may include an upper conveyance roller 20. The upper conveyance roller 20 is located to come into contact with the medium 99. The upper conveyance roller 20 is located to come into contact with a printing surface of the medium 99 on which printing is performed by the printing unit 12. The upper conveyance roller 20 is located to come into contact with the upper surface of the medium 99. Here, the upper conveyance roller 20 may be simply referred to as a conveyance roller.

The upper conveyance roller 20 is located upstream of the printing unit 12 in the conveyance direction Y1. The upper conveyance roller 20 is located upstream of the printing unit 12 in the conveyance direction Y1 so as not to come into contact with the image printed on the medium 99 during the reverse conveyance. The upper conveyance roller 20 is located upstream of the head 13 in the conveyance direction Y1.

The conveyance unit 19 may include a lower conveyance roller 21. The lower conveyance roller 21 is located to face the upper conveyance roller 20. The upper conveyance roller 20 and the lower conveyance roller 21 are located so as to sandwich the medium 99. The lower conveyance roller 21 is located to come into contact with the lower surface of the medium 99. The lower conveyance roller 21 is located upstream of the printing unit 12 in the conveyance direction Y1. Specifically, the lower conveyance roller 21 is located upstream of the head 13 in the conveyance direction Y1. The lower conveyance roller 21 is configured to be rotated by a motor, not illustrated, and convey the medium 99 in the direction opposite to the conveyance direction Y1. Also, the upper conveyance roller 20 rotates following the rotation of the lower conveyance roller 21 and the conveyance of the medium 99, and stabilizes the conveyance of the medium 99 by the lower conveyance roller 21.

The printing device 10 includes a detection unit 22. The detection unit 22 is attached to the printing unit 12. Specifically, the detection unit 22 is installed in the carriage 17. The detection unit 22 is located to face the medium 99. The detection unit 22 is located to face the support unit 18. The detection unit 22 may be located side by side with the head 13 in the carriage 17. For example, the detection unit 22 is located side by side with the head 13 in the conveyance direction Y1 in the carriage 17. In one example, the detection unit 22 is located downstream of the head 13 in the conveyance direction Y1. The detection unit 22 may be located upstream of the head 13 in the conveyance direction Y1. The detection unit 22 may be located to overlap the head 13 in the conveyance direction Y1. In this case, the detection unit 22 is located side by side with the head 13 in the scanning direction X1 in the carriage 17.

The detection unit 22 is configured to detect an adjustment image B1, described later. Specifically, the detection unit 22 is configured to detect the density of the adjustment image B1. The detection unit 22 includes a reflective optical sensor. The detection unit 22 includes a light emitting element and a light receiving element. The detection unit 22 irradiates the medium 99 with light, receives light reflected from the medium 99, and thus detects the adjustment image B1.

The printing device 10 may include a notification unit 23. The notification unit 23 is configured to notify of information. The notification unit 23 notifies the user of information by sound, light, or the like. The notification unit 23 is, for example, a display.

The printing device 10 may include an operation unit 24. The operation unit 24 is configured to accept an operation. The operation unit 24 accepts an operation from a user. The operation unit 24 is, for example, a touch panel.

The printing device 10 includes a control unit 25. The control unit 25 controls the printing unit 12. The control unit 25 controls the conveyance unit 19. The control unit 25 controls the detection unit 22. The control unit 25 controls the notification unit 23. The control unit 25 controls the operation unit 24. The control unit 25 comprehensively controls the printing device 10.

The control unit 25 may include one or more processors that execute various kinds of processing according to a computer program. The control unit 25 may be configured with one or more dedicated hardware circuits such as an ASIC that executes at least a part of the various kinds of processing. The control unit 25 may include a circuit including a combination of a processor and a hardware circuit. The processor includes a CPU and a memory such as a RAM and a ROM. The memory stores program codes or commands configured to cause the CPU to execute processing. The memory, that is, a computer-readable medium, includes any readable medium accessible by a general-purpose or dedicated computer.

### Processing by Control Unit

Next, processing by the control unit 25 will be described. The control unit 25 controls the printing unit 12 and the conveyance unit 19 to print an image on the medium 99.

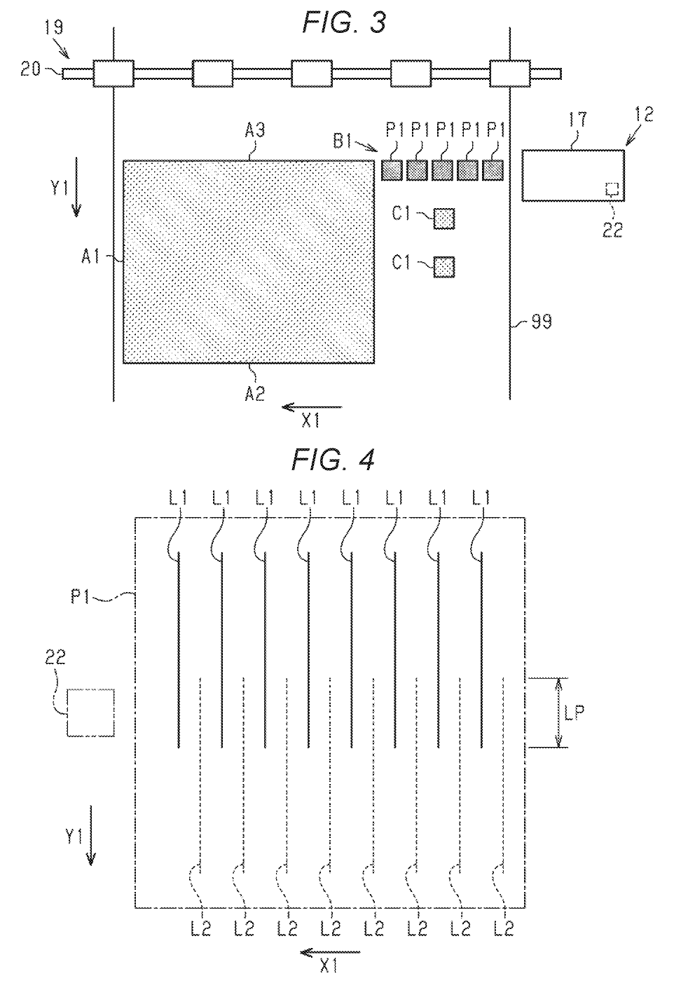

As illustrated in FIG. 3, the control unit 25 causes the printing unit 12 to print a job image A1 on the medium 99. That is, the printing unit 12 prints the job image A1 on the medium 99. The job image A1 is an image based on a print job. The job image A1 is an image contained in the print job. For example, when the print job contains a plurality of pages, one job image A1 illustrated in FIG. 3 is the job image A1 corresponding to one page. The print job contains a command to print one or more job images A1. The control unit 25 accepts the print job, for example, from the outside through a network and thus prints the job image A1, based on the print job. Upon accepting the print job, the control unit 25 causes the conveyance unit 19 to intermittently convey the medium 99 and causes the printing unit 12 to make a reciprocating motion along the scanning direction X1 to print the job image A1. The job image A1 may be an area where the job image A1 is allowed to be formed. For example, the job image A1 may include a plurality of objects located at a plurality of positions spaced apart from each other. In this case, a margin or the like between the objects is also an area where the job image A1 is allowed to be formed, and is contained in the job image A1.

The control unit 25 causes the printing unit 12 to print the adjustment image B1 on the medium 99. That is, the printing unit 12 prints the adjustment image B1 on the medium 99. The adjustment image B1 is an image for adjusting the ejection timing of the liquid by the printing unit 12. Specifically, the adjustment image B1 is an image for adjusting a first ejection timing and a second ejection timing. In one example, the adjustment image B1 is an image for adjusting the second ejection timing with respect to the first ejection timing. The adjustment image B1 may be an image for adjusting the first ejection timing with respect to the second ejection timing. The first ejection timing and the second ejection timing are different from each other. The control unit 25 adjusts the second ejection timing with respect to the first ejection timing, based on the adjustment image B1. The control unit 25 may adjust the first ejection timing with respect to the second ejection timing, based on the adjustment image B1.

The control unit 25 may perform printing such that the liquid ejected at the first ejection timing and the liquid ejected at the second ejection timing overlap each other. That is, the control unit 25 may perform printing such that the landing position of the liquid ejected at the first ejection timing and the landing position of the liquid ejected at the second ejection timing overlap each other. Specifically, the control unit 25 may perform printing such that the landing position of the liquid ejected at the first ejection timing and the landing position of the liquid ejected at the second ejection timing overlap each other in the scanning direction X1. In this case, the liquid ejected at the first ejection timing and the liquid ejected at the second ejection timing are located so as to be arranged in one line when viewed from the conveyance direction Y1.

The control unit 25 may perform bidirectional printing. In the bidirectional printing, the control unit 25 causes the printing unit 12 to eject a liquid in each of the outward path and the return path to print an image. The bidirectional printing is so-called Bi-D printing. In the bidirectional printing, the first ejection timing is an ejection timing during the movement on the outward path, and the second ejection timing is an ejection timing during the movement on the return path. That is, in the bidirectional printing, the first ejection timing and the second ejection timing are different from each other in the direction in which the carriage 17 moves. In the bidirectional printing, printing may be performed such that the liquid ejected in the outward path and the liquid ejected in the return path overlap each other. In bidirectional printing, printing may be performed such that landing positions of liquids ejected from the same nozzle row 16 are aligned.

The control unit 25 may perform unidirectional printing. In the unidirectional printing, the control unit 25 causes the printing unit 12 to eject a liquid in only one of the outward path and the return path to print an image. The unidirectional printing is so-called Uni-D printing. In the unidirectional printing, for example, the first ejection timing is an ejection timing during the movement on the outward path, and the second ejection timing is an ejection timing during the movement on the next outward path. That is, in the unidirectional printing, the first ejection timing and the second ejection timing are timings on different passes in which the carriage 17 moves in the same direction. In unidirectional printing, printing may be performed such that the liquid ejected in the outward path and the liquid ejected in the next outward path overlap each other. In the unidirectional printing, printing may be performed such that landing positions of liquids ejected from different nozzle rows 16 are aligned.

There is a risk that the ejection timing may gradually shift during printing. For example, when a plurality of job images A1 are continuously printed, there is a risk that the ejection timing may gradually shift during printing. Therefore, the control unit 25 prints the adjustment image B1 during the execution of the print job. The control unit 25 prints the adjustment image B1 with the printing of the job image A1. The control unit 25 prints the adjustment image B1 in parallel with the job image A1.

The adjustment image B1 includes one or more adjustment patterns P1. In one example, the adjustment image B1 includes a plurality of adjustment patterns P1. The adjustment image B1 includes, for example, five adjustment patterns P1. In the adjustment image B1, the plurality of adjustment patterns P1 are arranged in one direction. In the adjustment image B1, the plurality of adjustment patterns P1 are arranged in the scanning direction X1.

The adjustment pattern P1 is printed with the liquid ejected at the first ejection timing and the liquid ejected at the second ejection timing. The control unit 25 causes the printing unit 12 to eject the liquid at the first ejection timing and eject the liquid at the second ejection timing, and thus print the adjustment pattern P1. That is, the printing unit 12 ejects the liquid at the first ejection timing and ejects the liquid at the second ejection timing, and thus prints the adjustment pattern P1. The adjustment pattern P1 is a test pattern for checking the degree of overlap between the liquid ejected at the first ejection timing and the liquid ejected at the second ejection timing.

As shown in FIG. 4, the adjustment pattern P1 includes one or more first lines L1 and one or more second lines L2. The first line L1 is a line formed by the liquid ejected at the first ejection timing. The second line L2 is a line formed by the liquid ejected at the second ejection timing. The first line L1 and the second line L2 are rows of dots formed of the liquid ejected from the nozzle row 16. In the adjustment pattern P1, when the first line L1 and the second line L2 form one line, the landing position of the liquid ejected at the first ejection timing and the landing position of the liquid ejected at the second ejection timing coincide with each other. That is, in this case, the ejection timing is appropriate. FIG. 4 shows an example in which the first line L1 and the second line L2 do not form one line.

The first line L1 and the second line L2 are printed so as to form an overlapping part LP. The overlapping part LP is a part where the first line L1 and the second line L2 overlap each other when viewed from the scanning direction X1, in the adjustment pattern P1. The first line L1 and the second line L2 are printed so as to partially or entirely overlap each other in the conveyance direction Y1. The ejection timing is adjusted, based on the shift between the first line L1 and the second line L2 in the overlapping part LP.

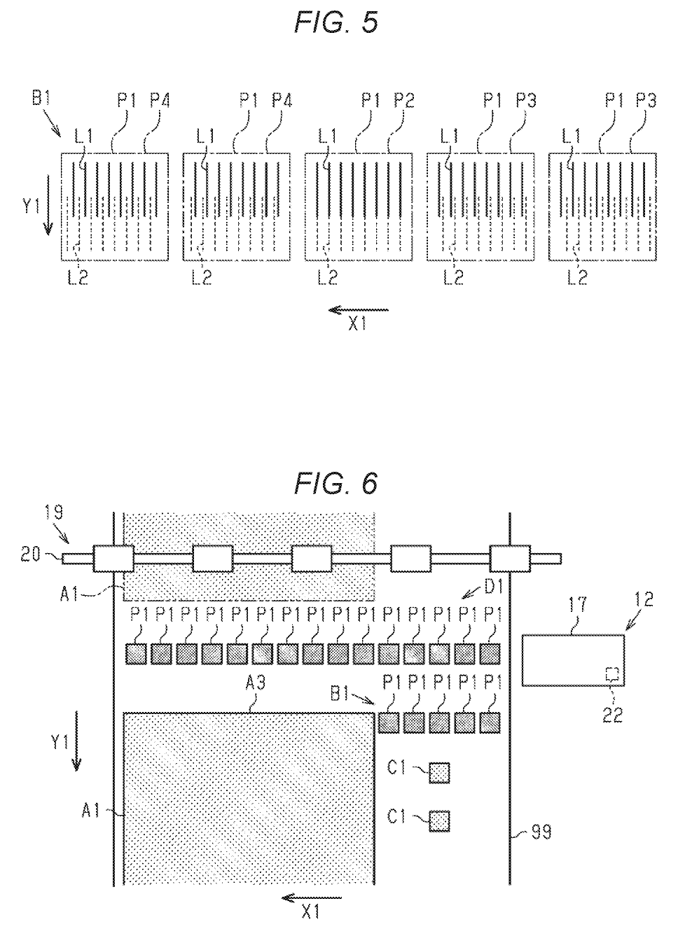

As shown in FIG. 5, the adjustment image B1 includes a reference adjustment pattern P2. The reference adjustment pattern P2 is the adjustment pattern P1 printed by ejecting the liquid at the currently set ejection timing. In one example, the reference adjustment pattern P2 is the adjustment pattern P1 printed by ejecting the liquid at the currently set second ejection timing.

The adjustment image B1 may include a plurality of adjustment patterns P1. The adjustment image B1 may include the adjustment pattern P1 in addition to the reference adjustment pattern P2. The plurality of adjustment patterns P1 are patterns printed at different ejection timings. In one example, the plurality of adjustment patterns P1 are patterns printed at different second ejection timings. The plurality of adjustment patterns P1 may be patterns printed at different first ejection timings.

The adjustment image B1 may include one or more positive adjustment patterns P3. The positive adjustment pattern P3 is the adjustment pattern P1 printed by ejecting the liquid at the ejection timing shifted in a positive direction from the currently set ejection timing. That is, the positive adjustment pattern P3 is the adjustment pattern P1 for which the ejection timing is shifted in the positive direction from the reference adjustment pattern P2. In one example, the positive adjustment pattern P3 is the adjustment pattern P1 for which the second ejection timing is shifted in the positive direction from the reference adjustment pattern P2.

The one or more adjustment patterns P1 may include one or more negative adjustment patterns P4. The negative adjustment pattern P4 is the adjustment pattern P1 printed by ejecting the liquid at the ejection timing shifted in a negative direction from the currently set ejection timing. That is, the negative adjustment pattern P4 is the adjustment pattern P1 for which the ejection timing is shifted in the negative direction from the reference adjustment pattern P2. In one example, the negative adjustment pattern P4 is the adjustment pattern P1 for which the second ejection timing is shifted in the negative direction from the reference adjustment pattern P2.

The plurality of positive adjustment patterns P3 are printed such that the amounts of shift of the ejection timing with respect to the reference adjustment pattern P2 are different from each other. The plurality of positive adjustment patterns P3 are printed, for example, by shifting the ejection timing in the positive direction by a predetermined amount each with respect to the reference adjustment pattern P2. The plurality of positive adjustment patterns P3 are printed by shifting the second ejection timing in the positive direction by a predetermined amount each with respect to the reference adjustment pattern P2.

The plurality of negative adjustment patterns P4 are printed such that the amounts of shift of the ejection timing with respect to the reference adjustment pattern P2 are different from each other. The plurality of negative adjustment patterns P4 are printed, for example, by shifting the ejection timing in the negative direction by a predetermined amount each with respect to the reference adjustment pattern P2. The plurality of negative adjustment patterns P4 are printed by shifting the second ejection timing in the negative direction by a predetermined amount each with respect to the reference adjustment pattern P2.

The control unit 25 is configured to adjust the ejection timing, based on the detection result of the adjustment image B1 by the detection unit 22. The control unit 25 causes the detection unit 22 to detect the adjustment image B1 and thus adjusts the ejection timing. Specifically, the control unit 25 causes the detection unit 22 to adjust one or more adjustment patterns P1 and thus adjusts the ejection timing. In one example, the control unit 25 adjusts the second ejection timing with respect to the first ejection timing, based on the detection result of the adjustment image B1.

The control unit 25 causes the detection unit 22 to detect the amount of shift between the first line L1 and the second line L2 in the adjustment pattern P1. The control unit 25 causes the detection unit 22 to detect the density of the overlapping part LP and thus detect the amount of shift between the first line L1 and the second line L2. When the amount of shift between the first line L1 and the second line L2 is large, the liquid uniformly lands in the overlapping part LP. When the amount of shift between the first line L1 and the second line L2 is small, the liquid lands unevenly in the overlapping part LP. Therefore, when the amount of shift between the first line L1 and the second line L2 is large, a high density of the overlapping part LP is detected.

The control unit 25 may adjust the ejection timing when the amount of shift between the first line L1 and the second line L2 in the reference adjustment pattern P2 is large. For example, when the density of the overlapping part LP is higher than a threshold value, the control unit 25 determines that the amount of shift between the first line L1 and the second line L2 is large. When the amount of shift between the first line L1 and the second line L2 in the reference adjustment pattern P2 is large, the control unit 25 may adjust the ejection timing, based on the density of the overlapping part LP.

The control unit 25 may adjust the ejection timing, based on the detection results of a plurality of adjustment patterns P1. The control unit 25 may adjust the ejection timing, based on the detection results of one or more positive adjustment patterns P3 and one or more negative adjustment patterns P4. The control unit 25 may change the ejection timing to the ejection timing for the adjustment pattern P1 having the lowest density of the overlapping part LP, of the plurality of adjustment patterns P1. That is, the control unit 25 may change the ejection timing to the ejection timing for the adjustment pattern P1 having the smallest amount of shift between the first line L1 and the second line L2, of the plurality of adjustment patterns P1. The control unit 25 may change the ejection timing to the ejection timing for the adjustment pattern P1 in which the density of the overlapping part LP is equal to or lower than the threshold value, of the plurality of adjustment patterns P1.

The control unit 25 may check with the user whether to adjust the ejection timing, based on the detection result of the adjustment image B1 by the detection unit 22. For example, the control unit 25 may prompt the user to adjust the ejection timing, based on the detection result of the adjustment image B1. When the amount of shift between the first line L1 and the second line L2 is large, the control unit 25 may cause the notification unit 23 to notify that the amount of shift between the first line L1 and the second line L2 is large. The control unit 25 may automatically adjust the ejection timing, based on the detection result of the adjustment image B1.

As illustrated in FIG. 3, when printing the job image A1, the control unit 25 prints the adjustment image B1 in a part that is a margin of the medium 99. Specifically, the control unit 25 prints the adjustment image B1 on a margin part of the medium 99 adjacent to the job image A1 in the scanning direction X1.

The control unit 25 prints the adjustment image B1 side by side with the job image A1. Specifically, the control unit 25 prints the adjustment image B1 side by side with the job image A1 in the scanning direction X1. That is, the control unit 25 prints both the job image A1 and the adjustment image B1 side by side with each other in the scanning direction X1. The control unit 25 causes the printing unit 12 to make a reciprocating motion along the scanning direction X1 and thus print the job image A1 and the adjustment image B1 in parallel. Since the adjustment image B1 is arranged side by side with the job image A1 in the scanning direction X1, the amount of medium consumption is smaller than when the adjustment image B1 is arranged side by side with the job image A1 in the conveyance direction Y1.

The control unit 25 prints the adjustment image B1 side by side with an upstream part of the job image A1 in the scanning direction X1. Specifically, the control unit 25 prints the adjustment image B1 such that the distance thereof from an upstream end A3 of the job image A1 is shorter than the distance thereof from a downstream end A2 of the job image A1 in the conveyance direction Y1. The downstream end A2 is an end part located downstream in the conveyance direction Y1, of the job image A1. The upstream end A3 is an end part located upstream in the conveyance direction Y1, of the job image A1. The downstream end A2 includes, for example, a line to be printed first in the job image A1. The upstream end A3 includes, for example, a line to be printed last in the job image A1. The control unit 25 may print the adjustment image B1 along with the printing of the final line of the job image A1.

The control unit 25 may print a check image C1. That is, the printing unit 12 may print the check image C1. The check image C1 is an image for checking the ejection states of the plurality of nozzles 14. The check image C1 is an image for checking a state where the liquid is not normally ejected from the nozzle 14, that is, so-called nozzle failure. The check image C1 is formed, for example, by simultaneously ejecting the liquid from all the nozzles 14. The user checks the check image C1 and thus checks whether the nozzle failure occurs.

The control unit 25 may print the check image C1 in a part that is a margin of the medium 99 when printing the job image A1. For example, the control unit 25 may print the check image C1 on a margin part of the medium 99 adjacent to the job image A1 in the scanning direction X1.

The control unit 25 may print the check image C1 side by side with the job image A1. In one example, the control unit 25 prints the check image C1 side by side with the job image A1 in the scanning direction X1. The control unit 25 prints both the job image A1 and the check image C1 side by side with each other in the scanning direction X1. The control unit 25 causes the printing unit 12 to make a reciprocating motion along the scanning direction X1 and thus print the job image A1 and the check image C1 in parallel.

The control unit 25 prints the check image C1 side by side with the adjustment image B1 in the conveyance direction Y1. Specifically, the control unit 25 prints the check image C1 so as to be located downstream of the adjustment image B1 in the conveyance direction Y1. That is, the control unit 25 prints the check image C1 before the adjustment image B1 during the printing of the job image A1. The control unit 25 prints the check image C1 such that the distance between the check image C1 and the downstream end A2 is shorter than the distance between the adjustment image B1 and the downstream end A2 in the conveyance direction Y1.

The control unit 25 may print a plurality of check images C1 during the printing of the job image A1. For example, the control unit 25 may print the check image C1 together with the job image A1 every time the printing unit 12 moves in the scanning direction X1. That is, the control unit 25 may print the check image C1 while printing the job image A1 for one line. In this case, the plurality of check images C1 are arranged in the conveyance direction Y1.

After the printing of the adjustment image B1 is completed, the control unit 25 causes the detection unit 22 to detect the adjustment image B1. Specifically, after the printing of the job image A1 and the adjustment image B1 is completed, the control unit 25 causes the detection unit 22 to detect the adjustment image B1. Therefore, after the printing of the job image A1 and the adjustment image B1 is completed, the control unit 25 adjusts the positions of the medium 99 and the detection unit 22 in the conveyance direction Y1 so that the detection unit 22 passes over the adjustment image B1. Since the adjustment image B1 is located side by side with the upstream part of the job image A1 in the scanning direction X1, the distance between the printing unit 12 and the adjustment image B1 is short when the printing of the job image A1 and the adjustment image B1 is completed. That is, the distance between the detection unit 22 and the adjustment image B1 is short. Thus, the time required for the detection of the adjustment image B1 by the detection unit 22 is short.

After the printing of the job image A1 and the adjustment image B1 is completed, the control unit 25 causes the conveyance unit 19 to reversely convey the medium 99 relatively to the printing unit 12, and thus aligns the positions of the detection unit 22 and the adjustment image B1. After the printing of the job image A1 and the adjustment image B1 is completed, the control unit 25 reversely rotates the upper conveyance roller 20 and thus aligns the positions of the detection unit 22 and the adjustment image B1. At this time, since the adjustment image B1 is located side by side with the upstream part of the job image A1 in the scanning direction X1, the amount of conveyance at the time of the reverse conveyance is small. Thus, the time required for the detection of the adjustment image B1 by the detection unit 22 is short. The printing device 10 may have a layout in which the detection unit 22 can pass directly above the adjustment image B1 without reversely conveying the medium 99 when printing of the job image A1 and the adjustment image B1 is completed. The printing device 10 may cause the conveyance unit 19 to convey the medium 99 relatively to the printing unit 12 and thus align the positions of the detection unit 22 and the adjustment image B1, after the printing of the job image A1 and the adjustment image B1 is completed.

When the medium 99 is reversely conveyed, there is a risk that the job image A1 may reach the upper conveyance roller 20. In this case, there is a risk that the job image A1 may be transferred to the upper conveyance roller 20. In contrast, the upper conveyance roller 20 is located upstream of the printing unit 12 in the conveyance direction Y1 so as not to come into contact with the job image A1 when the medium 99 is reversely conveyed. For example, the upper conveyance roller 20 is located upstream of the printing unit 12 such that the distance between the detection unit 22 and the adjustment image B1 is shorter than the distance between the upstream end A3 and the upper conveyance roller 20 in the conveyance direction Y1 when the printing of the job image A1 and the adjustment image B1 is completed. In other words, the control unit 25 causes the printing unit 12 to print the adjustment image B1 such that the distance between the detection unit 22 and the adjustment image B1 is shorter than the distance between the upstream end A3 and the upper conveyance roller 20 in the conveyance direction Y1 when the printing of the job image A1 and the adjustment image B1 is completed. Thus, the risk of the job image A1 being transferred to the upper conveyance roller 20 is reduced.

As illustrated in FIG. 6, the control unit 25 may print a main adjustment image D1. The main adjustment image D1 is an image including a plurality of adjustment patterns P1. The main adjustment image D1 is an image having a larger number of adjustment patterns P1 than the adjustment image B1. The main adjustment image D1 is an image containing a larger number of adjustment patterns P1 than the number of adjustment patterns P1 contained in the adjustment image B1. Specifically, the main adjustment image D1 is an image in which the number of positive adjustment patterns P3 and the number of negative adjustment patterns P4 are larger than in the adjustment image B1. The main adjustment image D1 may be an image including the adjustment pattern P1 in which the amount of shift between the first line L1 and the second line L2 is larger than in the adjustment image B1. The main adjustment image D1 may be an image including the adjustment pattern P1 in which the amount of shift between the first line L1 and the second line L2 is smaller than in the adjustment image B1. The main adjustment image D1 may include the reference adjustment pattern P2.

The control unit 25 may cause the printing unit 12 to print the main adjustment image D1, based on the detection result of the adjustment image B1 by the detection unit 22. For example, when it is determined that the ejection timing needs to be adjusted based on the detection result of the adjustment image B1, the control unit 25 may cause the printing unit 12 to print the main adjustment image D1. The control unit 25 may cause the printing unit 12 to print the main adjustment image D1 when the amount of shift between the first line L1 and the second line L2 in the reference adjustment pattern P2 contained in the adjustment image B1 is large. The control unit 25 may cause the printing unit 12 to print the main adjustment image D1 when the adjustment image B1 does not include the adjustment pattern P1 in which the amount of shift between the first line L1 and the second line L2 is equal to or less than the threshold value.

The control unit 25 may print the main adjustment image D1 side by side with the job image A1 in the conveyance direction Y1. In one example, the control unit 25 prints the main adjustment image D1 side by side with the job image A1 and the adjustment image B1 in the conveyance direction Y1. The control unit 25 prints the main adjustment image D1 after printing the job image A1 and the adjustment image B1. The control unit 25 prints the main adjustment image D1 before printing the next job image A1. The control unit 25 prints the main adjustment image D1 between the plurality of job images A1.

The control unit 25 causes the detection unit 22 to detect the main adjustment image D1 and thus adjusts the ejection timing. Similarly to the adjustment based on the adjustment image B1, the control unit 25 changes the ejection timing to the ejection timing for the adjustment pattern P1 having the smallest amount of shift between the first line L1 and the second line L2, of the plurality of adjustment patterns P1 contained in the main adjustment image D1. The control unit 25 changes the ejection timing to the ejection timing for the adjustment pattern P1 in which the amount of shift between the first line L1 and the second line L2 is equal to or less than the threshold value, of the plurality of adjustment patterns P1 contained in the main adjustment image D1. As compared with the detection result of the adjustment image B1, the detection result of the main adjustment image D1 indicates the amount of shift between the first line L1 and the second line L2 in detail. Therefore, the control unit 25 can finely adjust the ejection timing, based on the detection result of the main adjustment image D1.

The control unit 25 may print the main adjustment image D1 before printing the job image A1. Specifically, upon accepting a print job, the control unit 25 may print the main adjustment image D1 before starting printing the job image A1. The control unit 25 can appropriately print the first job image A1 by adjusting the ejection timing, based on the main adjustment image D1.

### Printing Processing

Next, the printing processing will be described. The printing processing is processing of printing an image on the medium 99. The printing processing is processing of printing the job image A1. The printing processing includes processing of printing the adjustment image B1. The printing processing is executed by the control unit 25. The printing processing is started when the control unit 25 accepts a print job.

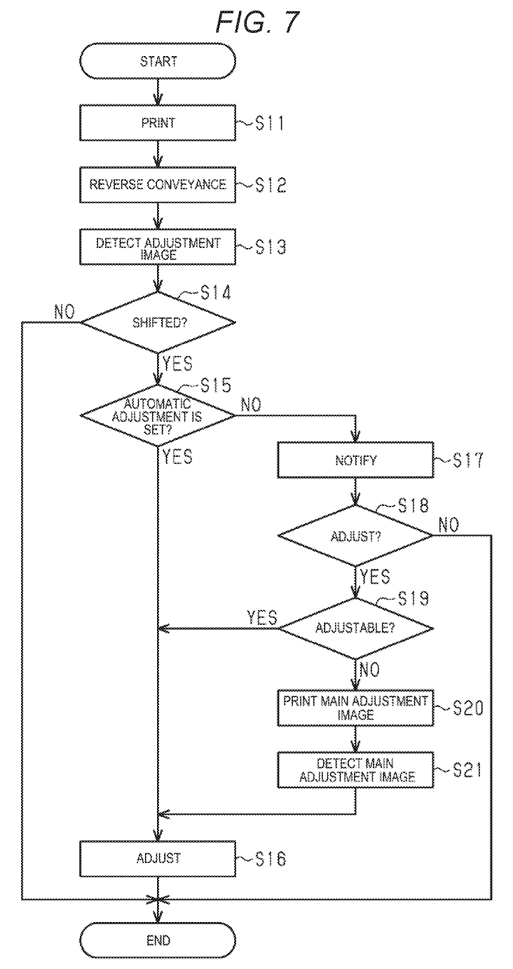

As shown in FIG. 7, in step S11, the control unit 25 prints an image, based on the print job. At this time, the control unit 25 alternately repeats the conveyance of the medium 99 by the conveyance unit 19 and the ejection of the liquid by the printing unit 12 and thus prints an image on the medium 99. The control unit 25 prints the job image A1. The control unit 25 prints the job image A1 and also prints the adjustment image B1. The control unit 25 prints the adjustment image B1 such that the adjustment image B1 is arranged side by side with the job image A1 in the scanning direction X1 and the distance thereof to the upstream end A3 is shorter than the distance thereof to the downstream end A2. The control unit 25 may print the check image C1 along with the printing of the job image A1.

In step S12, the control unit 25 causes the conveyance unit 19 to reversely convey the medium 99. For example, the control unit 25 rotates the upper conveyance roller 20 in the reverse direction and thus conveys the medium 99 in the direction opposite to the conveyance direction Y1. At this time, the control unit 25 causes the conveyance unit 19 to reversely convey the medium 99 so that the detection unit 22 can detect the overlapping part LP. The control unit 25 causes the conveyance unit 19 to reversely convey the medium 99 such that the detection unit 22 and the adjustment image B1 overlap each other in the conveyance direction Y1.

In step S13, the control unit 25 moves the printing unit 12 in the scanning direction X1 and thus detects the adjustment image B1. The control unit 25 detects the density of the overlapping part LP in the adjustment pattern P1 contained in the adjustment image B1.

In step S14, the control unit 25 determines whether the landing position of the liquid is shifted, based on the detection result of the adjustment image B1. That is, the control unit 25 determines whether the ejection timing needs to be adjusted. When the ejection timing does not need to be adjusted, the control unit 25 ends the printing processing. When the ejection timing needs to be adjusted, the control unit 25 shifts the processing to step S15.

In step S15, the control unit 25 determines whether the automatic adjustment of the ejection timing is set. That is, the control unit 25 checks whether the automatic adjustment of the ejection timing is permitted by the user. When the automatic adjustment of the ejection timing is permitted, the control unit 25 shifts the processing to step S16. When the automatic adjustment of the ejection timing is not permitted, the control unit 25 shifts the processing to step S17.

In step S16, the control unit 25 adjusts the ejection timing. The control unit 25 adjusts the ejection timing, based on the detection result of the adjustment image B1. For example, the control unit 25 changes the ejection timing to the ejection timing for the adjustment pattern P1 in which the amount of shift between the first line L1 and the second line L2 is the smallest. The control unit 25 may change the ejection timing, based on the amount of shift between the first line L1 and the second line L2. After adjusting the ejection timing, the control unit 25 ends the printing processing.

In step S17, the control unit 25 notifies the user that the ejection timing is shifted. At this time, the control unit 25 notifies the user that the ejection timing needs to be adjusted. For example, the control unit 25 causes the notification unit 23 to display a screen that prompts the adjustment of the ejection timing. The control unit 25 may cause the notification unit 23 to display a screen for accepting the adjustment of the ejection timing.

In step S18, the control unit 25 checks with the user whether to adjust the ejection timing. At this time, the control unit 25 may cause the notification unit 23 to display a screen for checking whether to adjust the ejection timing. The control unit 25 waits for an instruction from the user. When the control unit 25 accepts an instruction to adjust the ejection timing, the control unit 25 shifts the processing to step S19. When the control unit 25 accepts an instruction not to adjust the ejection timing, the control unit 25 ends the printing processing.

In step S19, the control unit 25 determines whether the ejection timing can be adjusted, based on the detection result of the adjustment image B1. That is, the control unit 25 determines whether the ejection timing can be adjusted, based on the detection result in step S13. For example, the control unit 25 checks whether the adjustment image B1 includes the adjustment pattern P1 in which the amount of shift between the first line L1 and the second line L2 is small. When it is determined that the ejection timing can be adjusted based on the detection result of the adjustment image B1, the control unit 25 shifts the processing to step S16. In this case, the control unit 25 adjusts the ejection timing, based on the detection result in step S13. When it is determined that the ejection timing cannot be adjusted based on the detection result of the adjustment image B1, the control unit 25 shifts the processing to step S20.

In step S20, the control unit 25 prints the main adjustment image D1. The control unit 25 prints the main adjustment image D1 at a position side by side with the job image A1 in the conveyance direction Y1. That is, after the medium 99 is conveyed by the conveyance unit 19, the control unit 25 causes the printing unit 12 to print the main adjustment image D1.

In step S21, the control unit 25 detects the main adjustment image D1. Specifically, the control unit 25 moves the medium 99 to a position where the main adjustment image D1 can be detected by the detection unit 22, and then moves the printing unit 12 in the scanning direction X1. For example, the control unit 25 reversely conveys the medium 99 and thus aligns the positions of the detection unit 22 and the main adjustment image D1, after the printing of the main adjustment image D1 is completed. The control unit 25 moves the printing unit 12 in the scanning direction X1 and thus causes the detection unit 22 to detect the main adjustment image D1. Upon acquiring the detection result of the main adjustment image D1, the control unit 25 shifts the processing to step S16. In this case, the control unit 25 adjusts the ejection timing, based on the detection result of the main adjustment image D1.

### Functions and Effects of Example

Then, the functions and effects of the example will be described.

(1) The control unit 25 causes the printing unit 12 to print the adjustment image B1 such that the adjustment image B1 is arranged side by side with the job image A1 in the scanning direction X1 and the distance thereof to the upstream end A3 is shorter than the distance thereof to the downstream end A2 in the conveyance direction Y1. With the above configuration, since the job image A1 and the adjustment image B1 are arranged side by side in the scanning direction X1, the amount of medium consumption is smaller than when the job image A1 and the adjustment image B1 are arranged side by side in the conveyance direction Y1. Since the adjustment image B1 is located near the upstream end A3 in the conveyance direction Y1, the positions of the adjustment image B1 and the printing unit 12 are close to each other when the printing of the job image A1 and the adjustment image B1 is completed. Therefore, the time required for the detection of the adjustment image B1 is shorter than when the positions of the adjustment image B1 and the printing unit 12 are spaced apart from each other when the printing of the job image A1 and the adjustment image B1 is completed. Therefore, the risk that the amount of medium consumption and the time required for the detection of the adjustment image B1 may increase is reduced.

(2) After the printing of the job image A1 and the adjustment image B1 is completed, the control unit 25 causes the conveyance unit 19 to reversely convey the medium 99 relatively to the printing unit 12 and thus aligns the positions of the detection unit 22 and the adjustment image B1. With the above configuration, the detection unit 22 can quickly detect the adjustment image B1.

(3) The upper conveyance roller 20 is located upstream of the printing unit 12 in the conveyance direction Y1 so as not to come into contact with the job image A1 when the medium 99 is reversely conveyed. With the above configuration, the risk of the job image A1 being transferred to the upper conveyance roller 20 is reduced.

(4) The control unit 25 causes the printing unit 12 to print the check image C1 such that the check image C1 is arranged side by side with the job image A1 in the scanning direction X1 and the distance between the check image C1 and the downstream end A2 is shorter than the distance between the adjustment image B1 and the downstream end A2 in the conveyance direction Y1. With the above configuration, the risk that the amount of medium consumption may increase due to the printing of the check image C1 is reduced.

(5) The printing unit 12 ejects the liquid at the first ejection timing and ejects the liquid at the second ejection timing, and thus prints the adjustment pattern P1. The first ejection timing and the second ejection timing are timings in movement directions of the carriage 17 that are different from each other or in passes that are different from each other. With the above configuration, the first ejection timing and the second ejection timing can be adjusted, based on the adjustment pattern P1.

(6) The control unit 25 checks with the user whether to adjust the ejection timing of the liquid by the printing unit 12, based on the detection result of the adjustment image B1 by the detection unit 22. With the above configuration, the risk of the ejection timing being automatically changed is reduced.

(7) The control unit 25 causes the printing unit 12 to print the main adjustment image D1, based on the detection result of the adjustment image B1 by the detection unit 22. With the above configuration, the ejection timing can be finely adjusted, based on the main adjustment image D1.

### Technical Ideas

Technical ideas figured out from the example and the modified examples described above, and the functions and effects thereof will hereinafter be described.

(A) A printing device includes: a printing unit that prints a job image and an adjustment image on a medium, the printing unit including a head that ejects a liquid onto the medium and a carriage in which the head is installed and that moves in a scanning direction with respect to the medium; a detection unit that is installed in the carriage and that detects the adjustment image including one or more adjustment patterns; a conveyance unit that relatively conveys the medium with respect to the printing unit in a conveyance direction different from the scanning direction; and a control unit that adjusts an ejection timing of the liquid, based on a detection result of the adjustment image by the detection unit, and the control unit causes the printing unit to print the adjustment image such that the adjustment image is arranged side by side with the job image in the scanning direction and a distance thereof to an upstream end of the job image is shorter than a distance thereof to a downstream end of the job image in the conveyance direction. With the above configuration, since the job image and the adjustment image are arranged side by side in the scanning direction, the amount of medium consumption is smaller than when the job image and the adjustment image are arranged side by side in the conveyance direction. Since the adjustment image is located near the upstream end of the job image in the conveyance direction, the positions of the adjustment image and the printing unit are close to each other when the printing of the job image and the adjustment image is completed. Therefore, the time required for the detection of the adjustment image is shorter than when the positions of the adjustment image and the printing unit are spaced apart from each other when the printing of the job image and the adjustment image is completed. Therefore, the risk that the amount of medium consumption and the time required for the detection of the adjustment image may increase is reduced.

(B) In the printing device, the control unit may cause the conveyance unit to reversely convey the medium relatively to the printing unit and thus align positions of the detection unit and the adjustment image, after the printing of the job image and the adjustment image is completed. With the above configuration, the detection unit can quickly detect the adjustment image.

(C) In the printing device, the conveyance unit may include an upper conveyance roller that conveys the medium, and the upper conveyance roller may be located upstream of the printing unit in the conveyance direction so as not to come into contact with the job image when the medium is reversely conveyed. With the above configuration, the risk of the job image being transferred to the upper conveyance roller is reduced.

(D) In the printing device, the head may include a nozzle surface provided with a plurality of nozzles from which a liquid is ejected, and the control unit may cause the printing unit to print a check image for checking an ejection state of the plurality of nozzles such that the check image is arranged side by side with the job image in the scanning direction and a distance between the check image and the downstream end is shorter than a distance between the adjustment image and the downstream end in the conveyance direction. With the above configuration, the risk that the amount of medium consumption may increase due to the printing of the check image is reduced.

(E) In the printing device, the printing unit may eject the liquid at a first ejection timing and eject the liquid at a second ejection timing different from the first ejection timing, and thus print the adjustment pattern, and the first ejection timing and the second ejection timing may be timings in movement directions of the carriage that are different from each other or in passes that are different from each other. With the above configuration, the first ejection timing and the second ejection timing can be adjusted, based on the adjustment pattern.

(F) In the printing device, the control unit may check with a user whether to adjust the ejection timing of the liquid by the printing unit, based on a detection result of the adjustment image by the detection unit. With the above configuration, the risk of the ejection timing being automatically changed is reduced.

(G) In the printing device, the control unit may cause the printing unit to print a main adjustment image containing a larger number of the adjustment patterns than the number of the adjustment patterns contained in the adjustment image, based on a detection result of the adjustment image by the detection unit. With the above configuration, the ejection timing can be finely adjusted, based on the main adjustment image.

What is claimed is:

1. A printing device comprising:
a printing unit configured to print a job image and an adjustment image on a medium, the printing unit including a head that ejects a liquid onto the medium and a carriage in which the head is installed and that moves in a scanning direction with respect to the medium;
a detection unit installed in the carriage and configured to detect the adjustment image including one or more adjustment patterns;
a conveyance unit configured to relatively convey the medium with respect to the printing unit in a conveyance direction different from the scanning direction; and
a control unit configured to adjust an ejection timing of the liquid, based on a detection result of the adjustment image by the detection unit, wherein
the control unit causes the printing unit to print the adjustment image such that the adjustment image is arranged side by side with the job image in the scanning direction and a distance thereof to an upstream end of the job image is shorter than a distance thereof to a downstream end of the job image in the conveyance direction.

2. The printing device according to claim 1, wherein
the control unit causes the conveyance unit to reversely convey the medium relatively to the printing unit and thus aligns positions of the detection unit and the adjustment image, after the printing of the job image and the adjustment image is completed.

3. The printing device according to claim 2, wherein
the conveyance unit includes a conveyance roller that conveys the medium, and
the conveyance roller is located upstream of the printing unit in the conveyance direction so as not to come into contact with the job image when the medium is reversely conveyed.

4. The printing device according to claim 1, wherein
the head includes a nozzle surface provided with a plurality of nozzles from which a liquid is ejected, and
the control unit causes the printing unit to print a check image for checking an ejection state of the plurality of nozzles such that the check image is arranged side by side with the job image in the scanning direction and a distance between the check image and the downstream end is shorter than a distance between the adjustment image and the downstream end in the conveyance direction.

5. The printing device according to claim 1, wherein
the printing unit ejects the liquid at a first ejection timing and ejects the liquid at a second ejection timing different from the first ejection timing, and thus prints the adjustment pattern, and
the first ejection timing and the second ejection timing are timings in movement directions of the carriage that are different from each other or in passes that are different from each other.

6. The printing device according to claim 1, wherein
the control unit checks with a user whether to adjust the ejection timing of the liquid by the printing unit, based on a detection result of the adjustment image by the detection unit.

7. The printing device according to claim 1, wherein
the control unit causes the printing unit to print a main adjustment image containing a larger number of the adjustment patterns than the number of the adjustment patterns contained in the adjustment image, based on a detection result of the adjustment image by the detection unit.
